(19) United States
(12) Patent Application Publication
(10) Pub. No.: US 2011/0214517 A1
(43) Pub. Date: Sep. 8, 2011

(54) Automatic Pipette Extraction

(75) Inventors: David E. Butz, Groton, MA (US); Michael T. Cupo, Leominster, MA (US)

(73) Assignee: BC ENTERPRISES, Groton, MA (US)

(21) Appl. No.: 13/040,385

(22) Filed: Mar. 4, 2011

Related U.S. Application Data
(60) Provisional application No. 61/310,326, filed on Mar. 4, 2010.

(51) Int. Cl. B01L 3/02

(52) U.S. Cl. 73/864.11

(57) ABSTRACT

An automatic extractor for volumetric pipettes includes a pair of gripping jaws. Each gripping jaw has a non-slip gripping surface juxtaposed symmetrically along a longitudinal pipette axis. The non-slip gripping surfaces are spaced apart from one another to provide ample room to place a volumetric pipette therebetween. A stationary support plate located above the pair of gripping jaws receives the nose of a hand-held pump while the stem of the attached pipette triggers an activation switch that closes the gripping jaws and removes the pipette.

### BACKGROUND

This invention relates to the automatic and mechanical removal of volumetric pipettes (such as serological pipettes) from the friction seal attachment into the nose cone of a hand-held, electronic pipette pump.

### BACKGROUND OF THE INVENTION

Volumetric pipettes are elongated graduated pipetting tubes used to transfer liquids, normally in the range of 1 ml to 100 ml. Volumetric pipettes include a tip for aspirating and dispensing the liquid, a main stem or barrel, and a collar or “mouthpiece” located at the top of the stem on the end opposite the tip. The diameter of the stem can vary substantially (e.g., about ¾ inch for a 50 ml pipette and about 1/16 inch for a 1 ml pipette) depending on the size of the pipette. On the other hand, the size of mouthpieces among various pipettes, while variable, is often about ¼ inch in order to facilitate attachment into the nose cone of a hand-held, electronic pipetting pump. The mouthpiece is normally integral or welded to the stem. Larger pipettes typically have a shoulder to transition between the diameter of the mouthpiece and the diameter of the stem. The electronic pumps typically include a handle with aspirate and dispense buttons for driving an electronic pumping mechanism. Normally, the nose cone of the pump includes a resilient friction fitting, sometimes referred to in the art as a grommet, into which the mouthpiece of the volumetric pipette is mounted. The friction fitting on the nose of the hand-held pump is normally able to accommodate a variety of pipette sizes.

Most volumetric pipettes in use today are disposable, sterilized and made of clear rigid plastic such as polystyrene or polypropylene, although some volumetric pipettes are made of glass or Pyrex. There are various types of volumetric pipettes. For example, in the art there is sometimes a distinction made between serological pipettes and Mohr pipettes. A serological pipette is a graduated pipette in which the calibration marks along its length extend all the way to the tip. On the other hand, some in the art use the term Mohr pipette to described a graduated pipette in which the calibration marks are confined along the length of the stem and do not extend all the way to the tip. For purposes herein, the term volumetric pipette should be construed broadly to mean conventional serological pipettes as well as Mohr pipettes, and other types of volumetric pipettes.

Laboratory workers often wear rubber gloves when using serological pipettes. To use a serological pipette, the lab worker unwraps the pipette from the sterile packaging, grasps the electronic, hand-held pump with one hand and the pipette with the other hand, and pushes the mouthpiece of the serological pipette into the friction fitting grommet in the nose cone of the hand-held pump. The friction fitting grommets are designed to require a significant amount of force to install the pipette, and especially to remove the pipette. It is important that the pipette forms a stable seal with the friction fitting grommet, and also that the pipette remains stable on the grommet during use. After the pipette has been used to aspirate and dispense liquids, the lab worker then manually extracts or removes the pipette from the friction fitting grommet. For workers operating the hand-held pump with their right hand, the worker grasps the pipette tightly with their left hand and then initiates the removal action which is normally characterized by a sudden jerking force to break the friction seal. Repeating the removal process for a large number of disposable pipettes over an extended period of time can lead to repetitive physical stress. When the lab worker is conducting procedures on a bench under a hood, the removal process can be especially awkward.

### SUMMARY OF THE INVENTION

The invention is directed to automated, electromechanical pipette extractors for extracting a volumetric pipette mounted into the nose cone of a hand-held pipetting pump. The embodiments of extractors illustrated herein are stand-alone electromechanical units that are well-suited for use on a laboratory bench or in like applications.

In accordance with a first aspect of the invention, an extractor is provided with at least two non-slip gripping surfaces juxtaposed from one another symmetrically along a longitudinal pipette axis and spaced apart from one another a sufficient distance to provide room for placing a portion of a stem of a volumetric pipette therebetween. With the volumetric pipette mounted into the friction fitting in the nose cone of a hand-held volumetric pipette pump, a portion of the stem of the pipette is placed between the juxtaposed gripping surfaces. Then, the gripping surfaces are simultaneously advanced towards the longitudinal pipette axis so that the gripping surfaces hold the stem of the pipette with contemporaneous opposing holding forces. In most embodiments of the invention, the non-slip gripping surfaces are spring mounted in order to accommodate pipettes having different diameters, and to provide gripping pressure. Once the stem of the pipette is held securely between the juxtaposed gripping surfaces, the non-slip gripping surfaces are moved simultaneously away from the nose of the hand-held pump to disengage the pipette from the friction fitting on the nose cone. Once the pipette has been disengaged from the friction fitting on the nose cone of the hand-held pump, the gripping surfaces are retracted away from the longitudinal pipette axis to release the pipette from the gripping surfaces. Normally, the pipette will then fall via the force of gravity into an appropriate receptacle. The gripping surfaces are then returned to their original positions ready for the next pipette extraction.

Desirably, the nose cone of the hand-held pump is supported against a stationary support surface on the extractor prior to pulling the volumetric pipette away from the nose cone. Also, it is desirable that the extractor include a sensor that senses the presence of the volumetric pipette between the juxtaposed gripping surfaces, such as a physical switch that is activated by the presence of the pipette between the gripping surfaces.

Other aspects of the invention are directed to various mechanical features of a volumetric pipette extractor. For example, as mentioned, the extractor includes a pair of gripping jaws each with a non-slip gripping surface juxtaposed symmetrically along the longitudinal pipette axis and spaced apart from one another to provide ample room to place a volumetric pipette therebetween. Desirably, the extractor includes a stationary support located above the pair of gripping jaws. The support receives the nose of the hand-held pump and includes an opening that provides access for a volumetric pipette extending downward from the nose of the pump to be aligned with the longitudinal pipette axis between the gripping jaws when the pipette is mounted to the friction fitting on the nose of the hand-held pump. The purpose of a stationary support is to allow the pipette to be pulled downward without requiring the user to hold the hand-held pump in place against sudden and substantial downward force.

The extractor also includes means for advancing the gripping jaws simultaneously towards the longitudinal pipette axis so that the gripping surfaces hold the stem of the volumetric pipette with contemporaneous opposing holding forces, and also means for pulling the pipette away from the stationary support to disengage the collar of the pipette from the nose of the hand-held pump. In one embodiment of the invention, the means for advancing the gripping jaws simultaneously towards the longitudinal pipette axis includes gripping surfaces that are mounted at the ends of spring loaded swing arms whose converging arcs of motion take the swing arms from their initial position towards the longitudinal pipette axis to engage the volumetric pipette. In this embodiment, the means for pulling the pipette away from the stationary support then involves the continued arc motion of the swing arms, with the spring loaded gripping surfaces, that pull the pipette longitudinally downward away from the friction fitting on the nose of the hand-held pump. In another exemplary embodiment of the invention, the gripping surfaces are spring mounted to a slide block or guide and an over-center linkage is used to lock the gripping surfaces in an open position against the force of the springs in order to spread the gripping surfaces to receive the pipette therebetween. The over-center linkage mechanism is released at the top of the stroke via a closing cam to allow spring force to push the gripping surfaces against the pipette. In this embodiment of the invention, the gripping surfaces are then moved downward via a crank mechanism to pull the pipette away from the stationary support to disengage the pipette collar from the nose of the hand-held pump. The gripping surfaces are opened via an opening cam against the force of the springs at the bottom of the stroke to release the pipette.

Other features and advantages of the invention may be apparent to those of ordinary skill in the art upon review of the following drawings and description thereof.

### BRIEF DESCRIPTION OF THE DRAWINGS

FIG. 1 is a perspective view of a hand-held pump with a volumetric pipette attached, and an automatic pipette extractor constructed in accordance with a first embodiment of the invention.

FIGS. 2A through 2C illustrate a method of extracting a volumetric pipette from the nose of a hand-held pipetting pump in accordance with the invention.

FIG. 3 is a top perspective view showing the volumetric pipette extractor of FIG. 1 immediately prior to the hand-held pump and the volumetric pipette being inserted into the extractor.

FIG. 4 is a front perspective view of the extractor shown in FIG. 1 with the housing taken away in order to show internal components.

FIG. 5 is a rear perspective view of the extractor shown in FIG. 1 again with the housing removed to show the internal components.

FIG. 6 illustrates use of the invention in a lateral orientation, as may be convenient for use under a laboratory hood or the like.

FIGS. 7A and 7B illustrate an extractor constructed in accordance with a second and third embodiment of the invention, respectively.

FIG. 8A illustrates and extractor constructed in accordance with the fourth embodiment of the invention.

FIG. 8B is a rear perspective view of the extractor illustrated in FIG. 8A.

FIG. 9 is a front view of internal components of the extractor shown in FIGS. 8A and 8B, and illustrates a lateral clamp mechanism with longitudinal gripping surfaces in accordance with this embodiment of the invention.

FIG. 10 is rear detailed view of the clamping mechanism illustrated in FIG. 9.

FIGS. 11A and 11B are detailed views of the slide mechanism illustrated in the fourth embodiment of the invention shown in FIGS. 8A-10.

FIG. 12 is a rear view illustrating internal components of the fourth embodiment of the invention illustrated in FIGS. 8A and 8B.

FIGS. 13A and 13B illustrated internal components of the electromechanical clamping assembly in the fourth embodiment of the invention illustrated in FIGS. 8A and 8B.

FIGS. 14A-F are schematic drawings illustrating the operation of an over-center linkage and spring actuated clamping mechanism for the gripping jaws in the fourth embodiment of the invention illustrated in FIGS. 8A and 8B.

FIG. 15 illustrates a pair of gripping jaws each having spaced apart, V-shaped ribs on the respective non-slip gripping surface.

### DETAILED DESCRIPTION OF THE DRAWINGS

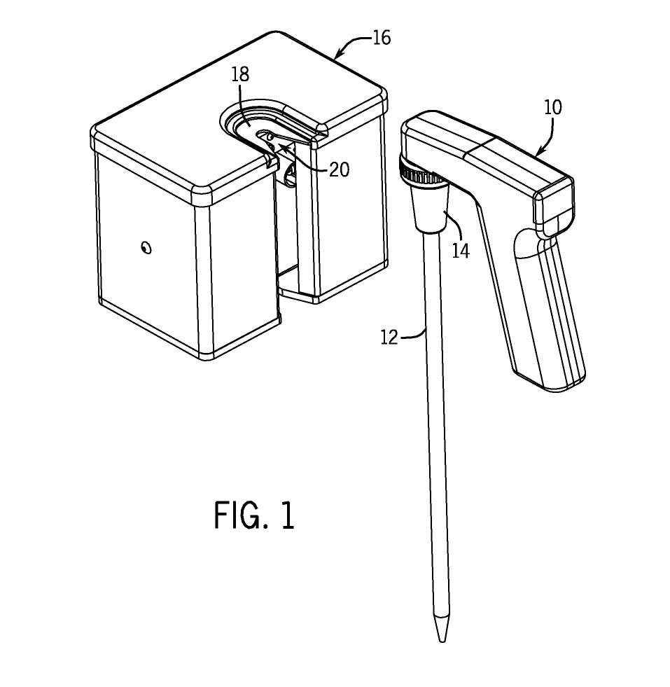

FIG. 1 shows a hand-held electronic pipetting pump 10. A volumetric pipette 12 is attached to a nose 14 of the pump 10 as is well known in the art. Although not specifically shown in the drawings, the mouthpiece or collar of the pipette 12 is held within the nose cone 14 via a friction fitting grommet as is also known in the art. An automatic volumetric pipette extractor 16 constructed in accordance with the invention is used to automatically remove the pipette 12 from the nose cone 14 of the pump 10. FIGS. 1-6 illustrate the construction and operation of the automatic pipette extractor 16 constructed in accordance with a first embodiment of the invention.

The extractor 16 includes a stationary support 18 for the nose 14 of the hand-held pump 10. The preferred form of a stationary support 18 is a rigid plate having a tapered opening 20. The purpose of the opening 20 is to allow access for the volumetric pipette 12 into the extractor 16 with the nose 14 of the pump 10 being held against a top surface of the plate 18.

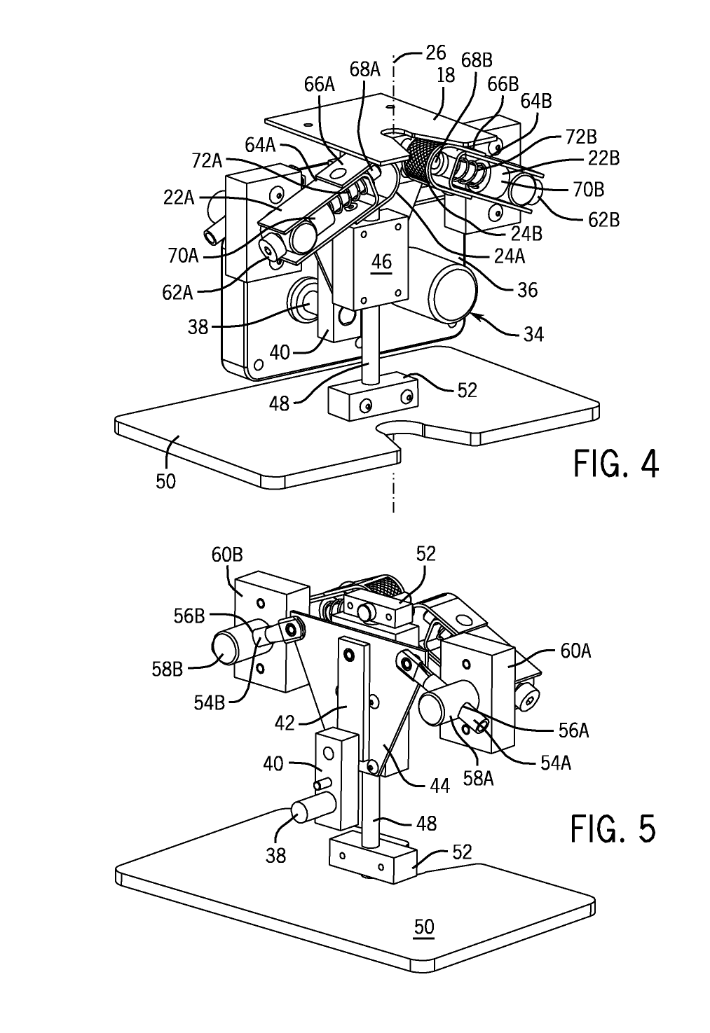

Referring now in particular to FIG. 4, the extractor 16 includes a pair of gripping jaws 22A, 22B which function to remove the pipette 12 from the nose 14 of the pump 10. The gripping jaws 22A, 22B include non-slip gripping surfaces 24A, 24B juxtaposed symmetrically along a longitudinal pipette axis depicted by phantom line 26 in FIG. 4. The non-slip gripping surfaces 24A, 24B are spaced apart from one another a sufficient distance to provide ample room to place the volumetric pipette 12 therebetween. Volumetric pipette 12 can take various sizes, and the distance between the non-slip gripping surfaces 24A, 24B on gripping jaws 22A, 22B in the start position as shown in FIG. 4 should be selected to provide clearance for the largest diameter pipette 12 for which the extractor is designed.

The non-slip gripping surfaces 24A, 24B can take several forms in accordance with the invention. In most applications, an abrasive non-slip surface such as a stamped knurl line, an embossed abrasive, or an abrasive strip will be sufficient and preferred. For applications involving reusable glass pipettes 12, it may be desirable to use a resilient elastomeric material for the non-slip surface 24A, 24B.

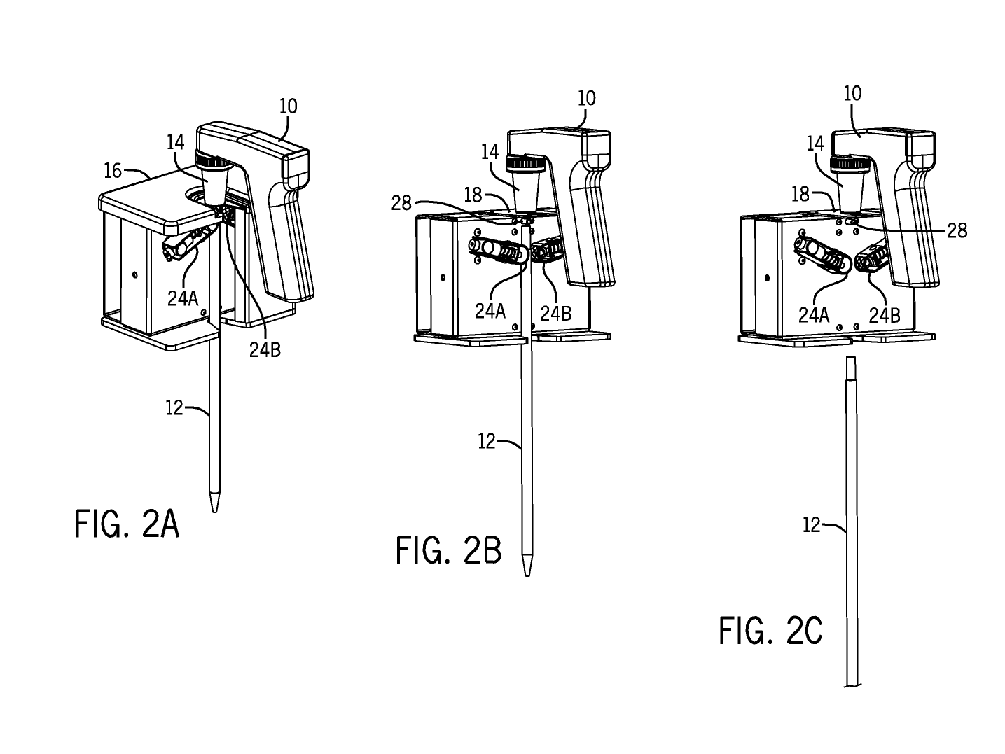

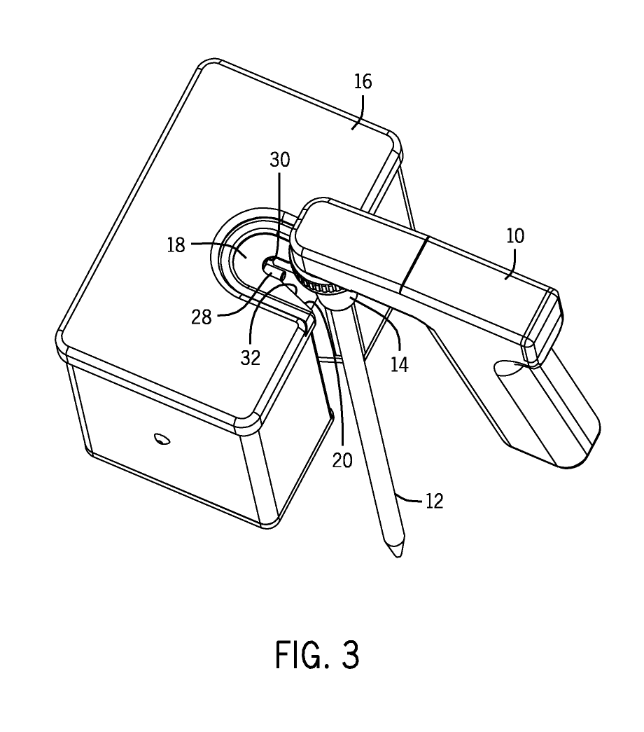

The gripping jaws 22A, 22B in this embodiment of the invention take the form of spring loaded swing arms with converging arcs of motion. Referring now to FIGS. 2A through 2C, the gripping surfaces 24A, 24B move from their initial position, FIG. 2A, towards the longitudinal pipette axis 26 to engage the volumetric pipette 12, FIG. 2B, and then along the longitudinal pipette axis 26 away from the stationary support 18 in order to pull the pipette 12 from the friction fitting grommet in the nose 14 of a hand-held pump 10, and finally away from the longitudinal pipette axis 26 in order to release the volumetric pipette 12, FIG. 2C. More specifically, an activation button 28 is provided to trigger the automatic extraction of pipette 12 mounted to the nose 14 of a hand-held pump 10, see also FIG. 3. The activation button 28 is located along the longitudinal pipette axis 26 just below the tapered opening 20 in the stationary support plate 18 for the nose 14 of the pump 10. When the pump 10 and pipette 12 are inserted into the extractor 16, with the nose 14 residing against the top surface of the support plate 18 and the stem of the pipette 12 being located between the juxtaposed gripping surfaces 24A, 24B, the stem of pipette 12 pushes against the activation button 28 to trigger an electronic motor mechanism to drive the downward arcuate motion of the gripping jaws 22A, 22B. FIG. 2A shows the pump 10 with the pipette 12 attached being inserted into the extractor 16 into a position in which the activation button 28 is depressed. Once the activation button 28 is activated, the gripping jaws 22A, 22B advance simultaneously toward the longitudinal pipette axis 26 so that the gripping surfaces 24A, 24B hold the stem of the pipette 12 with opposed contemporaneous holding forces. Then, with the stem of the pipette 12 held between the juxtaposed gripping surfaces 24A, 24B, the gripping jaws 22A, 22B continue to move simultaneously downward in an arcuate motion to pull the pipette 12 away from the support surface 18 and hence disengage the pipette 12 from the friction fitting on the nose 14 of the pump 10. FIG. 2B shows the operation of the extractor 16 sequentially in time after the activation button 28 has been pushed. In FIG. 2B, the initial part of the arcuate motion of the gripping jaws 22A, 22B has caused the pipette 12 to be pulled downward along the longitudinal pipette axis 26 away from the stationary support 18 and the nose 14 of the pump 10. At the point of operation illustrated in FIG. 2B, the pipette 12 is held securely between the gripping surfaces 24A, 24B. FIG. 2C shows the operation of the extractor 16 in a still later period of time after which the gripping jaws 22A, 22B have continued the arcuate path of motion such that the gripping surfaces 24A, 24B retract from the longitudinal pipette axis 26, thereby releasing the pipette from the gripping surfaces 24A, 24B. The release allows the pipette 12 to fall via the force of gravity into an appropriate receptacle for disposal, reuse or recycling. The gripping jaws 22A, 22B are then returned to the original starting position ready for the next pipette extraction. A built-in switch in the motor 34 can be used to stop the motor rotation after one revolution of the output shaft 38, or a separate physical tripping mechanism and switch can be used as is know in the art.

While the presence of the pipette 12 between the juxtaposed gripping surfaces 24A, 24B is sensed in this embodiment of the invention by activation button 28 other types of sensors such as optical sensors can be used to trigger the automatic extraction cycle. FIG. 3 in particular illustrates the preferred location and orientation of the mechanical activation button 28. Note that the tapered opening 20 in the support plate 18 includes a nose support portion 30 and a trough-shaped access portion 32. The dimensions of the nose support portion 30 are selected to be large enough to accommodate diameters of the pipettes 12 which the extractor 16 is designed to remove. Of course, the dimension of the nose support portion 30 must not be greater than necessary to support the nose 14 of conventional pumps. In the example shown in FIG. 3, a suitable dimension across the nose support portion 30 of the support plate 18 is ⅜ inches.

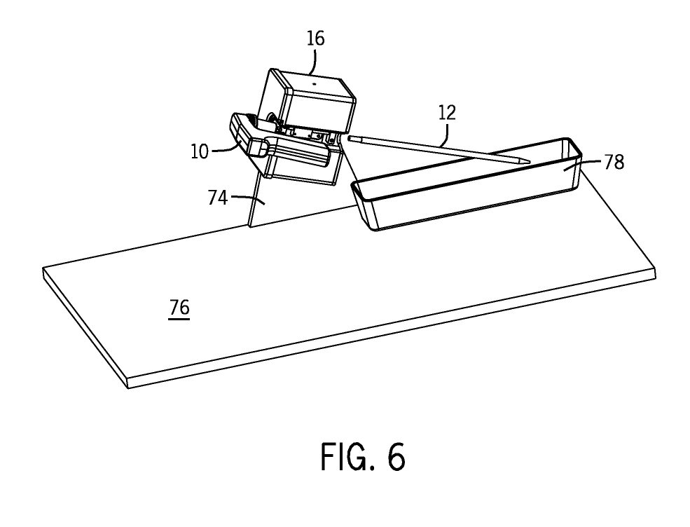

Turning now to FIGS. 4 and 5, the means for simultaneously advancing the gripping jaws to hold the stem of the pipette with contemporaneous opposing holding forces and to pull the pipette 12 away from the stationary support 18 to disengage the pipette from the nose 14 of the pump 10 includes an electric gear motor 34, and the mechanical linkage which converts simultaneous rotational motion to the gripping jaws 22A, 22B. The motor 34 is a DC motor that is connected to a gear box 36. Such motor 34 and gear box 36 combinations are typically sold as a single unit in the art. A suitable system for this application is a 12 volt DC motor with a 50 inch-pound running torque. The system shown in FIG. 4 provides a rotational output shaft 38 on the same side of the gear box 36 as the input motor 34. Referring to FIG. 5, the motor output shaft 38 is connected to a crank block 40 which in turn is pivotally connected to a connecting link 42. A triangular slide plate 44 is connected to the connecting link 42. Referring now also to FIG. 4, a slide block 46 is mounted to a front side of the slide plate 44. The slide block 46 includes a vertically disposed cylindrical opening which receives guide rod 48. Guide rod 48 is mounted vertically to the housing (not shown in FIGS. 4 and 5) of the extractor 16 via mounting blocks 52. The housing is mounted to the base 50. As the motor output shaft 38 rotates, it turns crank block 40 which is pivotally mounted to the lower end of the connecting link 42. The upper end of the connecting link 42 is pivotally mounted to the slide plate 44. The slide block 46 connected to the slide plate 44 and vertical guide rod 48 restrict the motion of the slide plate 44 to allow only vertical up and down motion depending upon the direction of rotation of the motor output shaft 38. The pivotal connection between the crank block 40 and the connecting link 42, on the one hand, and the connecting link 42 and the slide plate 44, on the other hand, translate the rotational motion of the motor output shaft 38 into vertical reciprocating movement of the triangular slide plate 44.

Pivot arms 54A, 54B are pivotally connected to the slide plate 44. The pivot arms 54A, 54B extend rigidly outward and are slidably engaged through an opening 56A, 56B in the respective swing shaft 58A, 58B. Each swing shaft 58A, 58B is mounted in a swing shaft mounting block 60A, 60B that is fixed to the housing of the extractor 16. The purpose of the swing shaft mounting block 60A, 60B is to maintain the longitudinal axis of the shaft 58A, 58B in a fixed perpendicularly forward and horizontal direction with respect to the extractor 16, while also allowing the swing shaft 58A, 58B to rotate around its axis. Because the axial location of the swing shafts 58A, 58B is fixed, upward or downward movement of the slide plate 44 and hence the respective pivot arms 54A, 54B causes the respective swing arm 58A, 58B to rotate. The pivot arms 54A, 54B are pivotally mounted to the slide plate 44 and slide in the respective openings 56A, 56B in the swing shaft 58A, 58B to translate up and down vertical movement of the slide plate 44 into rotational movement of the respective swing shafts 58A, 58B.

Referring now in particular to FIG. 4, the rotational movement of the respective swing shafts 58A, 58B causes the gripping jaws 22A, 22B to rotate simultaneously in an arcuate swing motion. As mentioned, the gripping jaws 22A, 22B are desirably spring loaded. Each gripping jaw has a shoulder screw 62A, 62B or the like that extends through an opening in the respective swing shaft 58A, 58B.

A slide saddle 64A, 64B is fitted over the shoulder screw 62A, 62B. The nose 66A, 66B of the gripping jaws 22A, 22B is attached to the slide saddle 64A, 64B, for example by riveting. The slide saddle 64A, 64B and the jaw noses 66A, 66B are preferably made of bent sheet metal. A threaded insert 68A, 68B is secured to the top of the slide saddle 64A, 64B, and is located within the jaw nose 68A, 68B against the face of the slide saddle 64A, 64B. A spacer 70A, 70B and a spring 72A, 72B are positioned between the swing shaft 58A, 58B and the face of the slide saddle 64A, 64B. The tension of the springs 72A, 72B is selected in order to provide sufficient opposing forces against the pipette to hold the pipette 12 and remove the pipette from the nose 14 of the pump 10. For example, it may be desirable to use a spring having the following characteristics 0.36 inches OD, 0.032 inch wire diameter, 1.25 inch fee length, 10 active turns. The use of spring-loaded gripping jaws 22A, 22B allows the extractor 16 to accommodate a full range of pipette diameters.

As depicted in FIGS. 1-5, the extractor is used in a vertical orientation, for example mounted along the edge of a lab bench so that there is clearance for the pipette.

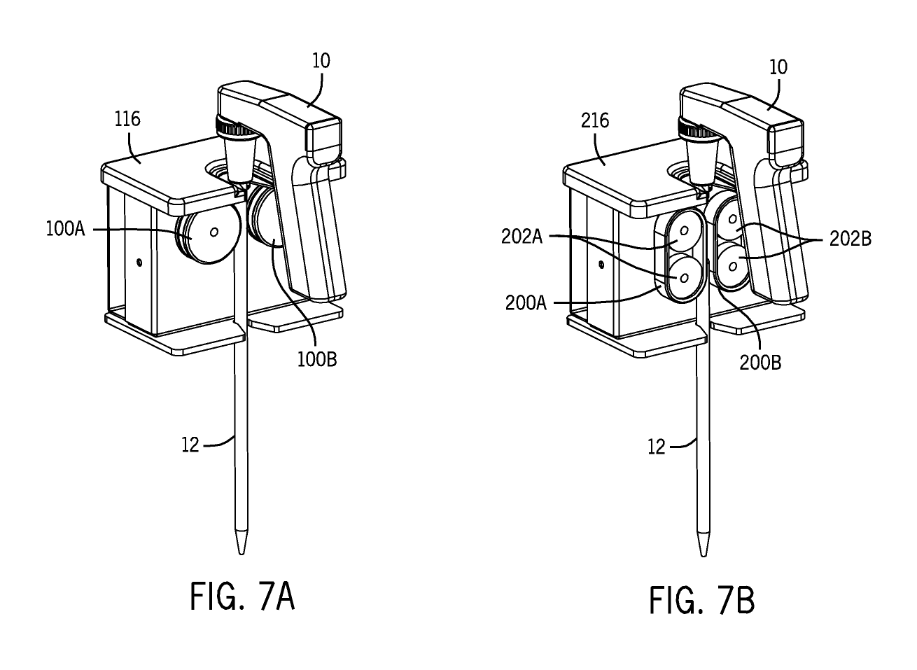

FIG. 6 illustrates the use of the extractor in a lateral or nearly lateral orientation as may be more convenient for use under a laboratory hood or the like. Referring to FIG. 6, a vertical mounting plate 74 is attached to a lab bench 76. The extractor 16 is mounted to the mounting plate 74 so that the longitudinal pipette axis (reference number 26 in FIG. 4) is nearly horizontal, e.g. with the bottom side of the extractor 16 being lower than the top side of the extractor 16 along a slope of about 10° relative to horizontal. When the user places the pump 10 with the pipette 12 attached thereto into the extractor 16, the extractor 16 is activated and pulls the pipette 12 off of the pump 10 in the direction of the longitudinal pipette axis 16 (not shown in FIG. 6). The release of the pipette 12 occurs in essentially the same manner as described above with FIGS. 1-5, although the pipette 12 is released to the side of the extractor 16 and allowed to fall into receptacle 78 sitting on the lab bench 76. As mentioned, the configuration shown in FIG. 6 is particularly well suited for work under a hood where it may be difficult for the user to raise their hand high enough to properly use the extractor 16 if it were vertically mounted as in FIG. 1-5.

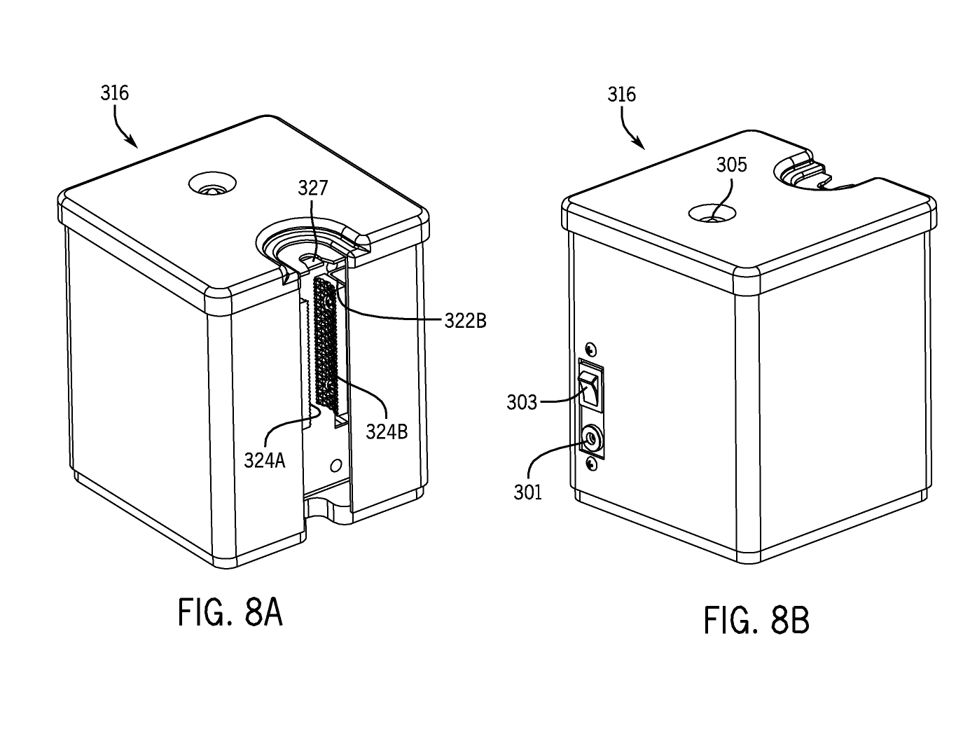

FIGS. 7A and 7B illustrate a second and third embodiment of the invention. In FIG. 7A, the extractor 116 includes wheels 100A, 100B which have opposed gripping surfaces, instead of the gripping jaws 22A, 22B illustrated in the first embodiment shown in FIGS. 1-6. In FIG. 7B, the extractor 216 includes a pair of belts 200A, 200B as the gripping surfaces. Each respective belt 200A, 200B in the embodiment shown in FIG. 7B is driven by a pair of rollers 202A, 202B. As in the first embodiment of the invention shown in connection with FIGS. 1-6, both of the extractors 116, 216 shown in FIGS. 7A and 7B include an activation sensor (not shown) to trigger the start of the pipette 12 removal process. Prior to beginning the removal process, there must be clearance between the gripping surfaces to allow room for the insertion of the pipette 12 therebetween. Therefore, for the embodiments 116, 216 shown in FIGS. 7A and 7B it is desirable for the wheels 100A, 100B in FIG. 7A and the belts 200A, 200B in FIG. 7B to move closer to one another upon triggering of the activation sensor by the pipette 12 in order to grip the pipette 12, prior to pulling it downward and removing it from the pump 10. Suitable mechanical means for moving the wheels 100A, 100B or rollers 200A, 200B include swing arms, scissor mechanisms or the like.

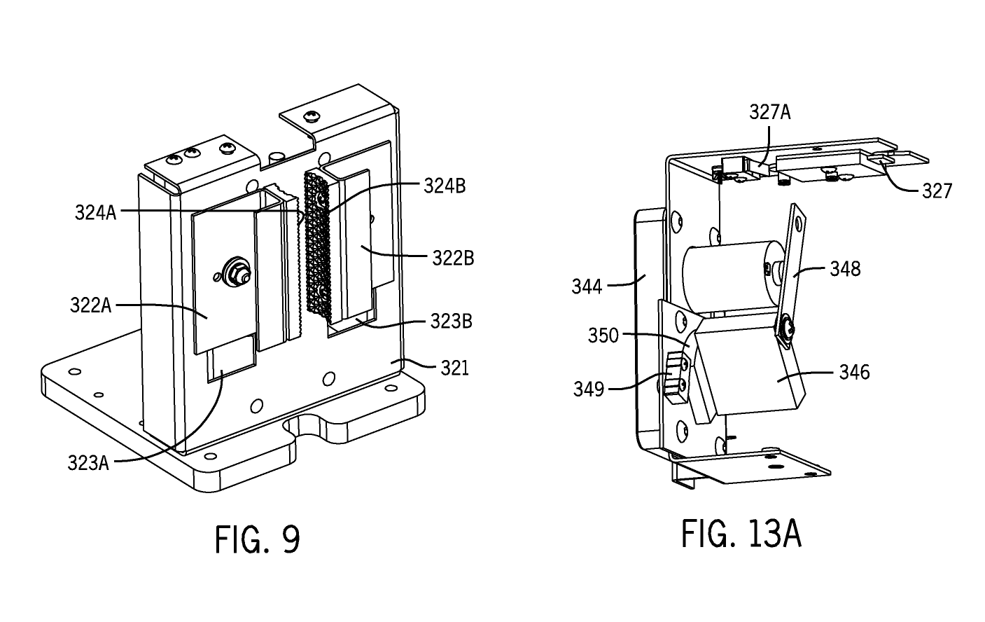

FIGS. 8A and 8B through 14A-14F illustrate an extractor 316 constructed in accordance with a fourth embodiment of the invention. The extractor 316 includes a pair of gripping jaws 322A, 322B with longitudinal gripping surfaces 324A, 324B. The non-slip gripping surfaces 324A, 324B as in the other embodiments are spaced apart from one another a sufficient distance to provide room to place a volumetric pipette 12 therebetween. As in the other embodiments, the extractor 316 includes an activation blade 327 that is triggered to automatically extract a pipette 12 mounted to the nose 14 of a hand-held pump 10. When the activation blade 327 is triggered, the jaws 322A, 322B move laterally towards one another such that the juxtaposed non-slip gripping surfaces 324A, 324B grip the pipette 12. The jaws 322A, 322B are then mechanically moved downward to remove the pipette 12, and at the end of the stroke the jaws 322A, 322B are withdrawn laterally outward to release the pipette 12. The lateral clamping motion implemented by the extractor 316 in this embodiment of the invention is well suited to accommodate variations in pipette diameter. In the embodiment shown in FIGS. 1-7, the result of the arcuate swing is that pipettes of different diameters are engaged at different contact angles. Thus, if the center-to-center location of the swing arms is set to clamp the smallest diameter pipettes between the jaws 22A, 22B that contact angle can occur too early in the swinging motion for larger diameter pipettes. When this occurs, the extracting motion can operate at a mechanical disadvantage and can possibly jam. This problem can be resolved in the earlier embodiment by making the swing arms longer but that requires enlargement on the overall size of the device. The extractor 316 in the embodiment described in FIGS. 8A and 8B through 14A-14F always clamps in a direction perpendicular to the pipette axis, thereby eliminating the mechanical disadvantage problem discussed above with respect to the use of swing arms.

FIG. 8B is the rear view of the extractor 316, and it shows a power jack 301, and on/off switch 303, and an LED light 305 which indicates whether the extractor 316 is turned on.

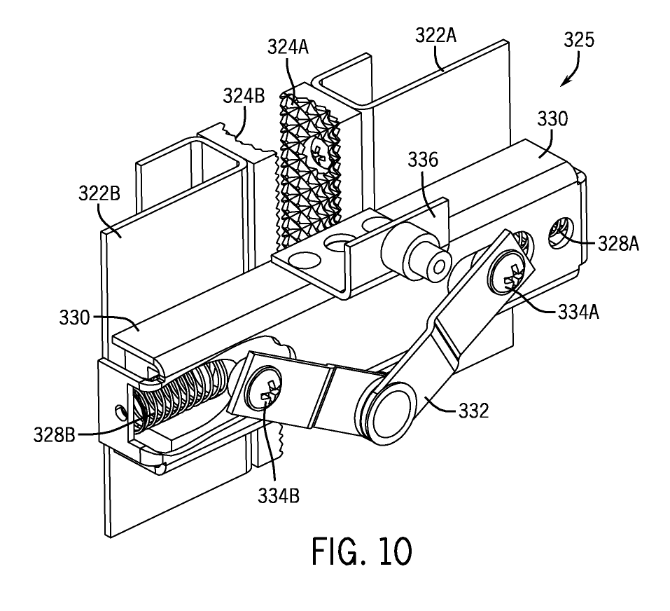

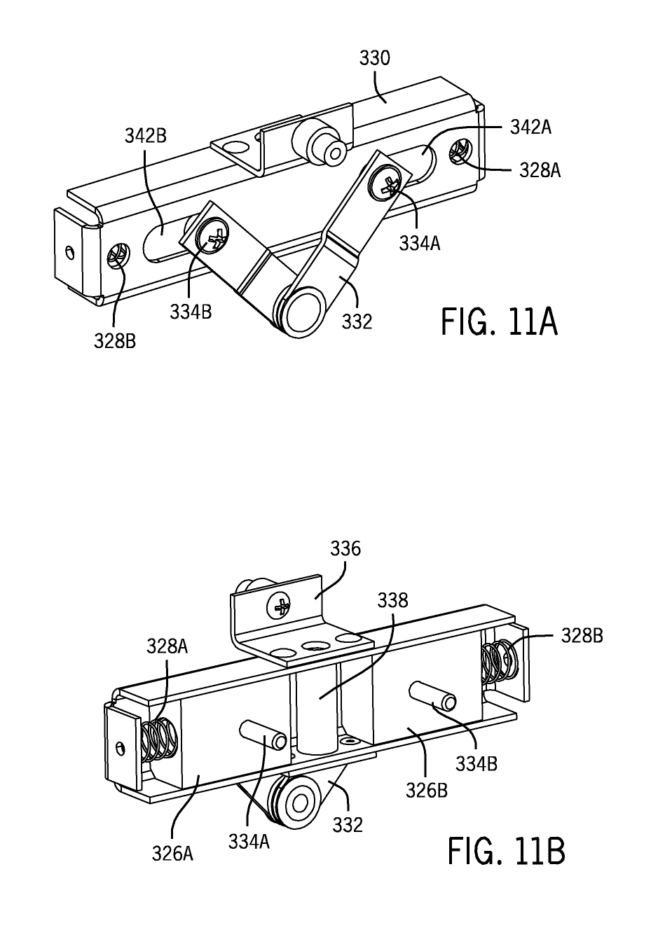

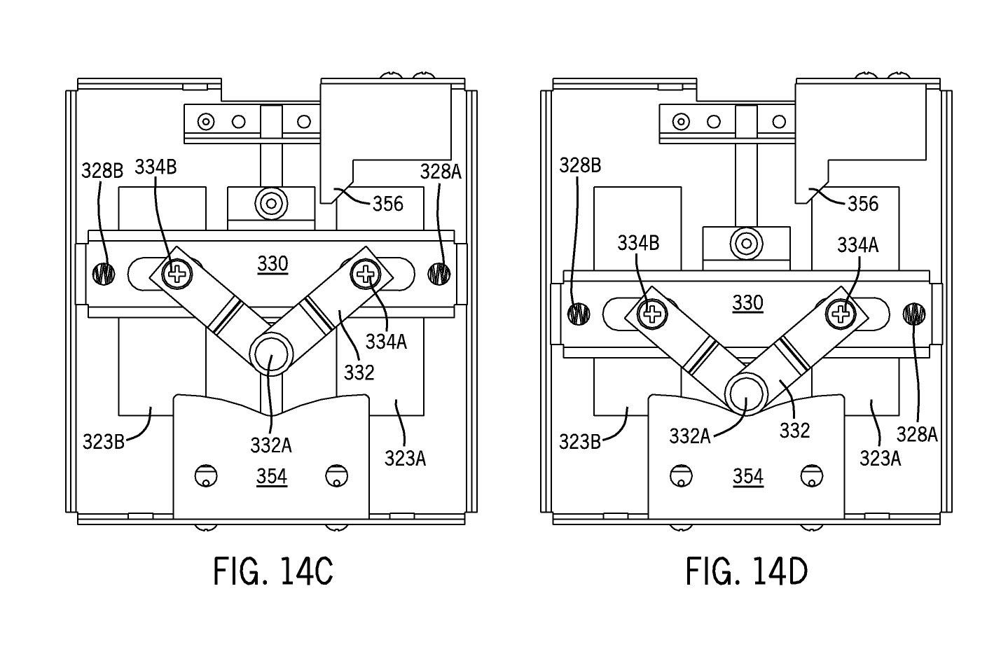

Referring to FIG. 9, the gripping jaws 322A, 322B are preferably made of bent metal plates with the non-slip gripping surfaces 324A, 324B attached thereto. The gripping jaws 322A, 322B move laterally and vertically within slots 323A, 323B in support plate 321. FIG. 10 shows details of the clamping mechanism 325 for the gripping jaws 322A, 322B. The clamping mechanism 325 includes slide blocks 326A, 326B which are spring loaded, see springs 328A, 328B mounted in a slide channel 330. A toggle, over-center linkage 332 is connected via through-bolts 334A, 334B to the slide blocks 326A, 326B and the gripping jaws 322A, 322B. A lifting bracket 336 is mounted to the top of the slide channel 330. The lifting bracket 336 includes an opening for a vertical shaft 352 (FIG. 13B) that guides the vertical movement of the slide channel 330 during operation.

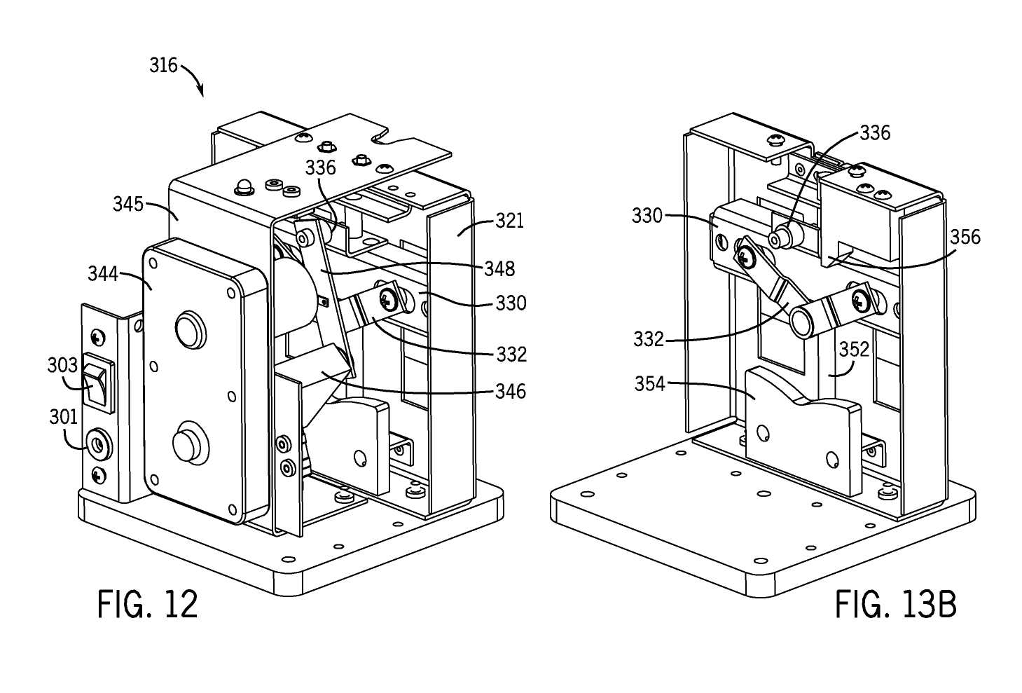

FIGS. 11A and 11B show the clamping mechanism 325 from the rear side of the extractor 316 and the front side of the extractor 316, respectively. Referring to FIG. 11A, the slide channel 330 includes slots 342A, 342B to allow lateral movement of the through-bolts 334A, 334B. Referring to FIG. 11B, a vertical guide shaft bushing 338 is shown on the interior of the slide channel 330. FIG. 11B also illustrates the through-bolts 334A, 334B passing through the spring loaded slide blocks 326A, 326B. The specific design of the clamping mechanism and the spring loaded slide blocks can take on different variations within the scope of the invention. For example, extension springs rather than compression springs can be used. Also, horizontal guide rods can be used for the sliding blocks rather than a slide channel.

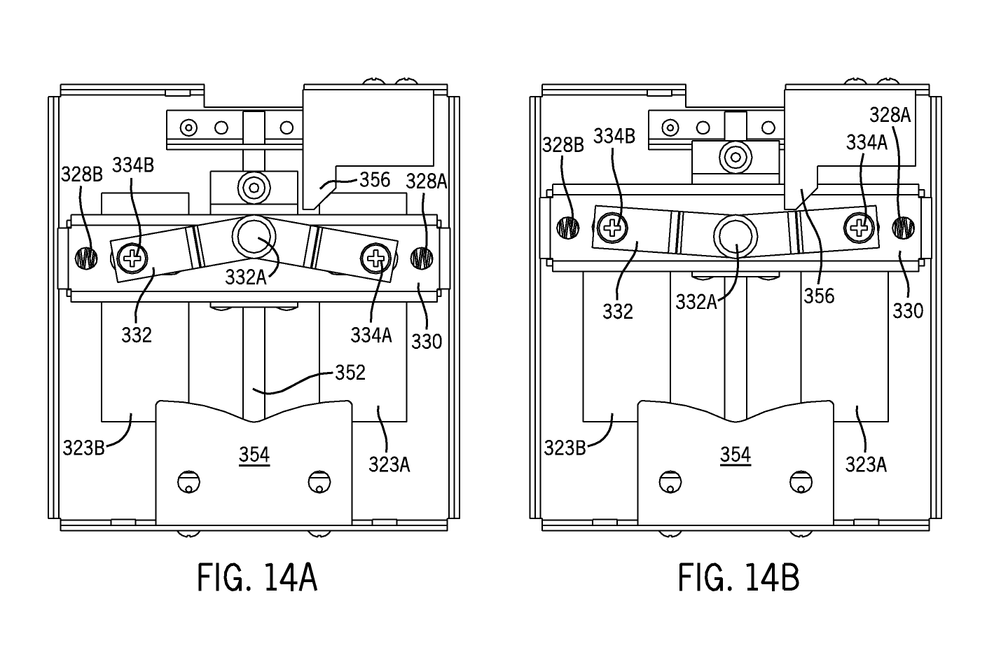

FIG. 12 illustrates internal components from the rear of the extractor 316. The extractor 316 includes a gear motor 344 mounted on an internal frame plate 345. The gear motor 344 drives a crank 346 and a crank arm 348. The upper end of the crank arm 348 is pivotally attached to the lifting angle 336 in order to lift and lower the slide channel 330. FIGS. 13A and 13B illustrate internal components of a cam actuated electro-mechanical mechanism in the extractor 316. Referring to FIG. 13A, the gear motor 344 turns the crank 346. The crank 346 is attached to a switch cam 350. The switch cam 350 mechanically cooperates with an off switch 349. The trigger mechanism, which includes micro switch 327A and the trigger blade 327, is activated by the presence of a pipetter to begin the extraction cycle for the gear motor 344. The off switch 349 and the switch cam 350 turn off the gear motor when the extraction cycle is complete. Referring to FIG. 13B, the slide channel 330 holding the gripping jaws (322A, 322B, FIGS. 8A and 10) moves vertically along the guide shaft 352. The crank arm 348 (see FIGS. 12 and 13A) as mentioned previously is attached to the lifting bracket 336 to lift and lower the slide channel 330. As the slide channel 330 is lifted and lowered, the over-center linkage 332 closes to grip a pipette to be extracted and opens to release the pipette via interaction with closing cam 356 and opening cam 354, respectively.

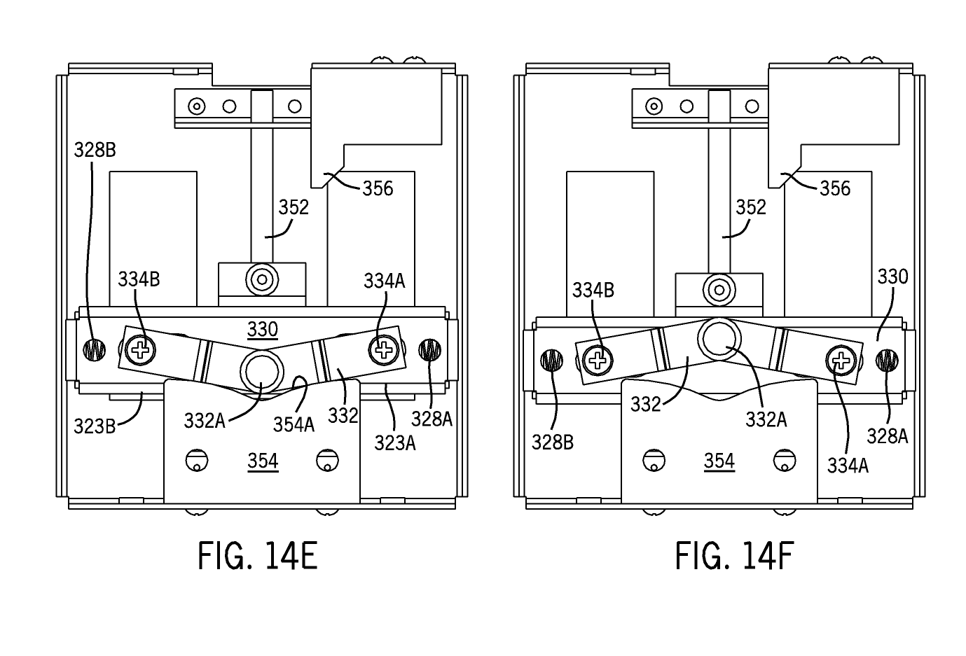

The operation of the over-center linkage 332 and the clamping mechanism is described in detail in connection with FIGS. 14A through 14F. In FIG. 14A, the over-center linkage 332 and the slide channel 330 are located in a start or resting position to which it has been returned upward after releasing the previous pipette. Note that the position in FIG. 14A is short of the top of the stroke. Also note that the center pivot 332A of the over-center linkage 332 is located above the through pins 334A, 334B, i.e. the over-center linkage 332 is in a toggle up state in which the over-center linkage 332 locks the gripping surfaces 324A, 324B in an open position against the force of the springs 328A, 328B (See FIG. 11B). As the crank arm 348 moves the slide 330 upward to the top of the stroke, one side of the linkage 332 comes into contact with the closing cam 356 as shown in FIG. 14B. This contact forces the over-center linkage 332 into a toggle down state in which the center pivot 330A is below the through pins 334A, 334B. As soon as the linkage 332 passes center, the springs 328A, 328B in the slide channel 330 force the clamping jaws 322A, 322B inward until the gripping surfaces 324A, 324B clamp against the pipette. In other words, when the linkage 332 is in the toggle down state, the linkage 332 provides little or no resistance to the pressure of the springs 328A, 328B, see FIG. 11B. This spring loaded over-center linkage and gripping mechanism is well suited to accommodate pipettes having a wide variety of diameters.

FIG. 14C shows the position of the over-center linkage 332 after the jaws have been snapped shut on a pipette and have moved downward to strip the pipette from the nose of the hand-held pump. FIG. 14D shows a position later in the stroke after the pipette has been removed from the nose and the linkage 332 begins to contact the bottom opening cam 354. The linkage 332 pushes the through pins 334A, 334B and slide blocks 326A, 326B (FIG. 11B) outward against the force of the springs 328A, 328B to release the pipette. FIG. 14E illustrates continued opening of the clamping jaws. Note that the top surface of the opening cam 354 has a smoothly curved cam contact surface 354A which becomes less steep as the surface moves from the middle of the cam 354 to its outer edges. While the opening action may be affected by a simple, flat top central blade or post, the opening cam 354 illustrated with the contoured blade 354A gradually changes the contact position with the toggle arms. The contoured cam action works in concert with the changing mechanical advantage that occurs with the toggle linkage angle as it approaches 180°, and therefore allows for a shorter toggle opening stroke. This increases the amount of downward stroke available for pipette extraction, which enables the vertical height of the extractor to be kept at a minimum.

Further motion in the cycle will take the slide block 330 to the bottom of the stroke which will push the center pivot 332A into the toggle up position. Referring to FIG. 14 F, at this point in the cycle, the opening cam 354 has pushed the over-center linkage into the toggle up position in which the center pivot 332A is above the through pins 334A, 334B. The crank arm 348 will continue to move the slide block 330 to complete the cycle back to the initial resting system shown in FIG. 14A with the linkage in the toggle up position and the gripping jaws 322A, 322B spread apart at a distance ready to receive the next pipette to be extracted. At this point the switch cam 350 and off switch 349 stop the gear motor 344.

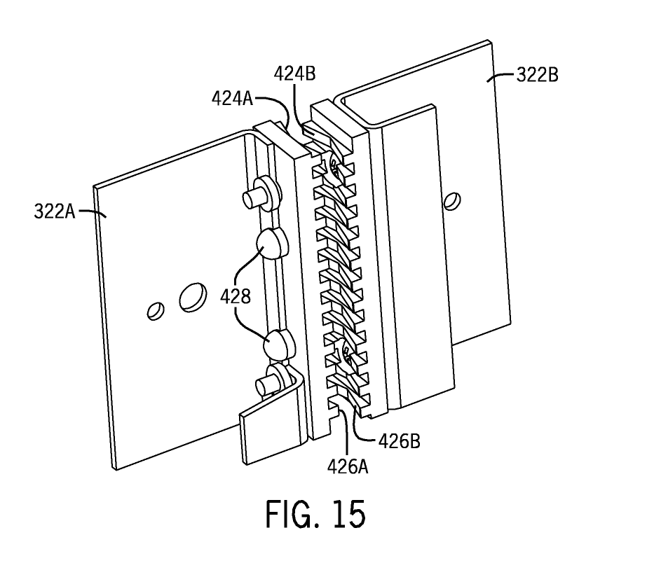

FIG. 15 illustrates an alternative arrangement for the non-slip gripping surfaces 424A, 424B. The gripping interface is a line contact on each side of a pipette if the gripping pads are flat, whether they are rigid or elastomeric. More gripping contact can be provided if the gripping surfaces 424A, 424B are concave, e.g., a concave curved or V-shaped surface. In FIG. 15, the gripping surfaces 424A, 424B attached to the clamp mounting jaws 322A, 322B have spaced apart V-shaped ribs 426A, 426B. Each pair of V-shaped rib surfaces 426A, 426B provides four points of contact for the pipette rather than two points of contact if a flat pad were used, and therefore provides better, more stable gripping of the pipette. The V-shaped rib surfaces 426A, 426B are well suited to accommodate pipettes with different diameters. Further, it is desirable, as shown in FIG. 15, that the gripping surfaces consist of a series of spaced apart V-shaped ribs 426A, 426B rather than continuous V-shaped surfaces. The spaced apart V-shaped ribs 426A on one side are vertically offset from the spaced apart V-shaped ribs 426B on the other side so that the ribs 426A, 426B overlap when clamping together around the smallest diameter pipettes. The effect is similar to providing greater effective concavity for smaller diameter pipettes and results in more stable gripping for smaller and larger diameter pipettes alike.

Mounting protrusions 428 can also be integrally molded into the backside of the gripping elements. The mounting protrusions 428 pass through the respective bent clamp mounting jaw 322A, 322B and provide increased resistance to shear forces present when removing a pipette. If the mounting protrusions 428 are asymmetrically located on the jaw 322A, 322B, then assuming that the same manufactured components are used for jaws 322A, 322B and the gripping surfaces 424A, 424B, the V-shaped ribs 426A, 426B can be configured to bypass each other as desired when the bent metal mounting jaw 322B is rotated 180° for mounting onto the extractor.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A method of extracting a volumetric pipette mounted into a nose cone of a hand-held pipetting pump, the method comprising the steps of:
a) providing a volumetric pipette mounted to a friction fitting in a nose cone of a hand-held, volumetric pipette pump;
b) providing two or more non-slip gripping surfaces juxtaposed from one another symmetrically along a longitudinal pipette axis and spaced apart from one another a sufficient distance to provide room for placing a portion of a stem of the volumetric pipette between the juxtaposed gripping surfaces;
c) placing a portion of the stem of the volumetric pipette between the juxtaposed gripping surfaces when the volumetric pipette is mounted to the friction fitting of the hand-held pump;
d) advancing the non-slip gripping surfaces simultaneously towards the longitudinal pipette axis so that the gripping surfaces hold the stem of the pipette with contemporaneous opposing holding forces;
e) once a portion of the stem of the pipette is held between the juxtaposed gripping surfaces, simultaneously moving the non-slip gripping surfaces to pull the pipette away from the nose of the hand-held pump and disengage the pipette from the friction fitting on the nose cone of the hand-held pump; and
f) after the pipette has been disengaged from the friction fitting on the nose cone of the hand-held pump, retracting the gripping surfaces away from the longitudinal pipette axis so that the pipette is released from the gripping surfaces.

2. A method as recited in claim 1 further comprising the step of allowing the pipette to fall via the force of gravity into an appropriate receptacle once the pipette is released from the gripping surfaces after it has been disengaged from the friction fitting on the nose of the hand-held pump.

3. A method as recited in claim 1 further comprising the step of:
g) returning the gripping surfaces to the original positions of the gripping surfaces ready for the next pipette extraction.

4. A method as recited in claim 1 further comprising the step of supporting the nose cone of the hand-held pump against a stationary support surface prior to pulling the volumetric pipette away from the nose cone.

5. A method as recited in claim 1 wherein the gripping jaws are spring loaded, and the holding forces against the stem of the serological pipette are provided by the respective springs.

6. A method as recited in claim 1 wherein the non-slip gripping surfaces are rigid non-slip surfaces.

7. A method as recited in claim 1 wherein the gripping surfaces are resilient non-slip surfaces.

8. A method as recited in claim 1 wherein steps (d) through (f) are automatically implemented in response to sensing the presence of the volumetric pipette between the juxtaposed gripping surfaces.

9. A method as recited in claim 3 wherein the steps of (d) through (g) are automatically implemented in response to sensing the presence of the volumetric pipette between the juxtaposed gripping surfaces.

10. A method as recited in claim 8 wherein the presence of the volumetric pipette between the juxtaposed gripping surfaces is sensed by a mechanical switch.

11. A method as recited in claim 8 wherein the presence of the volumetric pipette between the juxtaposed gripping surfaces is sensed by an optical sensor.

12. A method as recited in claim 1 wherein the gripping surfaces are mounted at the ends of spring loaded swing arms whose converging arcs of motion take the swing arms from their initial position towards the longitudinal pipette axis to engage the volumetric pipette, then along the longitudinal pipette axis away from the friction fitting on the nose of the hand-held pump, then away from the longitudinal pipette axis to release the volumetric pipette, and then in the reverse direction through a return arc to their initial starting position.

13. A method as recited in claim 1 wherein the gripping surfaces are mounted on spring-loaded mounting arms and an over-center linkage locks the gripping surfaces on the mounting arms in an open position against the force of the springs in order to keep the gripping surfaces spread to receive a pipette therebetween and is released to allow the force of the springs to move the gripping surfaces on the mounting arms into a closed position in order to engage and extract the pipette located between the gripping surfaces.

14. A volumetric pipette extractor comprising:
a pair of gripping jaws each with a non-slip gripping surface juxtaposed symmetrically along a longitudinal pipette axis and spaced apart from one another to provide ample room to place a volumetric pipette therebetween;
a stationary support located above the pair of gripping jaws to receive a nose of a hand-held pump, the support containing an opening that provides access for a volumetric pipette to be aligned with the longitudinal pipette axis when the volumetric pipette is mounted to a friction fitting on the nose of the hand-held pump;
means for advancing the gripping jaws simultaneously towards the longitudinal pipette axis so that the gripping surfaces hold the stem of the volumetric pipette with contemporaneous opposing holding forces and for pulling the pipette away from the stationary support to disengage a collar of the pipette from the nose on the hand-held pump.

15. A volumetric pipette extractor as recited in claim 13 wherein the gripping jaws are spring loaded.

16. A volumetric pipette extractor as recited in claim 13 further comprising a mechanical switch located adjacent the pipette opening in the stationary support which is activated when a volumetric pipette is placed along the longitudinal pipette axis.
